(19) United States
(12) Patent Application Publication
(10) Pub. No.: US 2017/0269871 A1
(43) Pub. Date: Sep. 21, 2017

(54) DATA STORAGE SYSTEM WITH PERSISTENT STATUS DISPLAY FOR MEMORY STORAGE DEVICES

(71) Applicant: Intel Corporation, Santa Clara, CA (US)

(72) Inventors: Jawad B. Khan, Cornelius, OR (US); Randall K. Webb, Portland, OR (US); Kai-Uwe Schmidt, Vancouver (CA); Robert W. Dmitroca, Vancouver (CA)

(73) Assignee: Intel Corporation, Santa Clara, CA (US)

(21) Appl. No.: 15/071,966

(22) Filed: Mar. 16, 2016

(51) Int. Cl. G06F 3/06; G09G 3/34; G06T 1/60; G06F 11/07

(52) U.S. Cl. CPC G06F 3/0653; G06F 3/0619; G06F 3/0673; G06F 11/0727; G06F 11/0769; G09G 3/344; G06T 1/60

(57) ABSTRACT

A data storage system is described with a persistent status display. In one example, the system has an external housing, a persistent display attached to the exterior of the housing, a display controller within the housing coupled to the display to write status data to the display, a memory array to store data within the housing, a memory controller within the housing to control the operation of the memory array and to determine a status of the memory array, the memory controller being coupled to the display controller to send status data to the display controller to write to the display, and an exterior connector coupled to the memory controller to send data from the memory to an external device.

### FIELD

The present description pertains to the field of data storage systems, and in particular to a system with a persistent status display for memory devices.

### BACKGROUND

High capacity, high speed, and low power memory is in demand for many different high powered computing systems, such as servers, entertainment distribution head ends for music and video distribution and broadcast, and super computers for scientific, prediction, and modeling systems. The leading approach to provide this memory is to mount a large number of memory drives in a rack mounted chassis. The memory drives may use spinning hard disk, flash, or perhaps other memory technologies. The chassis has a backplane to connect to each memory drive and to connect the drives to other rack mounted chassis for computation or communication. The memory drives connect using SAS (Serial Attached SCSI (Small Computer System Interface)), SATA (Serial Advanced Technology Attachment), or PCIe (Peripheral Component Interface express) or other storage interfaces.

When a system has a large number of memory drives and it is exposed to heavy use, then the drives will eventually fail. Many multiple drive systems use LEDs (Light Emitting Diodes) to indicate the status of each drive installed into the system. A green LED indicates that the drive is operational and a red LED indicates that the drive has failed or is not operating for some other reason. In some cases LCDs (Liquid Crystal Display) are used on a shared display that will indicate a particular drive and a status as operational or failed. Such a display is able to indicate the drive to be replaced to a technician.

In order to provide deeper information regarding the status of each drive and the various hosts and memory controllers, some memory array and rack mount computing system provide remote management services. Status and operational information for storage and processing systems is collected by a management system and presented at a terminal. In the event of a failure or service event, the technician notes the precise position of any suspect hardware and moves to that position in order to remove it. The information from the management system is then associated with the removed component in order to service that component.

### BRIEF DESCRIPTION OF THE DRAWINGS

Embodiments are illustrated by way of example, and not by way of limitation, in the figures of the accompanying drawings in which like reference numerals refer to similar elements.

FIG. 1 cross-sectional side view diagram of memory system according to an embodiment.

FIG. 2 is an isometric view of a memory system with a top cover removed according to an embodiment.

FIG. 3 is a top plan view of a memory system with a top cover removed according to an embodiment.

FIG. 4 is a side plan view of a memory card according to an embodiment.

FIG. 5 is a top plan view of the memory card of FIG. 4.

FIG. 6 is a cross-sectional side view diagram of an alternative memory system according to an embodiment.

FIG. 7 is an isometric view of another alternative memory system according to an embodiment.

FIG. 8 is a block diagram of a memory system and administration according to an embodiment.

FIG. 9 is a partial isometric view of a memory card with a housing and multiple persistent displays according to an embodiment.

FIG. 10 is a partial isometric view of a memory system with a top cover removed showing an array of memory cards according to an embodiment.

FIG. 11 is an isometric view of a memory card with an alternative configuration and housing and multiple persistent displays according to an embodiment.

FIG. 12 is a block diagram of a computing device incorporating a memory system or capable of accessing a memory system according to an embodiment.

### DETAILED DESCRIPTION

When a fault condition of any kind occurs with a memory drive, a visual indicator is a great aid to help a technician identify the drive that has experienced the fault. When the indicator is in a chassis, controller, bracket, or carrier then after the drive is removed, the indicator is no longer available. Even when the indicator is attached directly to the drive, when the drive is removed, the indicator can only be seen when power is applied to the drive. Even when power is applied, there is a risk that any error information may have changed after the drive has been removed from a system. This may be due to no longer being installed in the system or due to time elapsing since the fault or error as detected.

As described herein a persistent display is attached directly to the exterior housing of the drive. This allows the display to be visible on or from the exterior of the drive. The display may be built into the housing, as shown, or an external display. A fault or error status for that specific drive that has been written to the persistent display is not lost or changed after time has elapsed. The status is also readable without the need to apply power to the drive. For more complex information there may be sufficient data so that remote management information is not required in order to assess and repair the drive.

As described herein a persistent or bistable display, such as an electrophoretic display (e.g. E-ink® display) may be attached directly to a memory drive housing. Status information may be written to the display by a memory controller or by a host system or both. The displayed information does not require power to maintain its state. As a result, the display and the displayed information remains with the drive after the drive is removed from the storage array or chassis. The status can be observed from the display without any additional equipment. In addition to the drive being equipped to independently write to the display using an internal memory controller, external devices may write to the display. The host system may have access to this display through a control or system management bus to update the state of the display. This is useful in case the drive is not able to detect the error and in case the drive controller has a flaw that prevents it from writing to the display, e.g. the controller is internally hung or inoperable.

In the administration of a large memory system such as may happen in a server bank, a data hosting system, or a download center, there may be many memory drives that may all fail in different ways and at different times. A technician is able to replace faulty drives with known operational drives. This ensures that the data, computing, or broadcasting station stays operational. However, after a drive is removed, it must be repaired, refurbished, or discarded. It is difficult to accurately tag each drive with its particular condition after having removed it from the system because the information is not generally marked on the drive but in an external management system. Using the persistent display, the technician can immediately read the last status update and immediately determine whether to repair, refurbish, or destroy the drive.

A memory system is described that provides dense All Flash Array (AFA) designs. The system has front or top serviceability of an array of flash storage modules, as well as excellent airflow characteristics. In the case of a top serviceable model a cable management solution is used at the back for sliding the chassis out of the rack. Front serviceable storage modules avoid the need for the chassis to slide out of the rack because there is no need to open the top cover to service the storage modules. Yet the system may still be mounted to a sliding carrier to allow for other modules to be serviced without removing the chassis, such as fans, interconnects, controllers, switches, and computing modules.

As described dense memory storage boxes have high airflow, heat dissipation and storage density using a thin and long SSD form factor. This SSD will be referred to herein as a “Ruler Storage Module”, “RSM” or “ruler”. Several RSMs may be used in a 19″ wide rack-mount SSD system. They may be placed in a single row multiple column arrangement, which helps guide the airflow and provides maximum surface area for the NAND media.

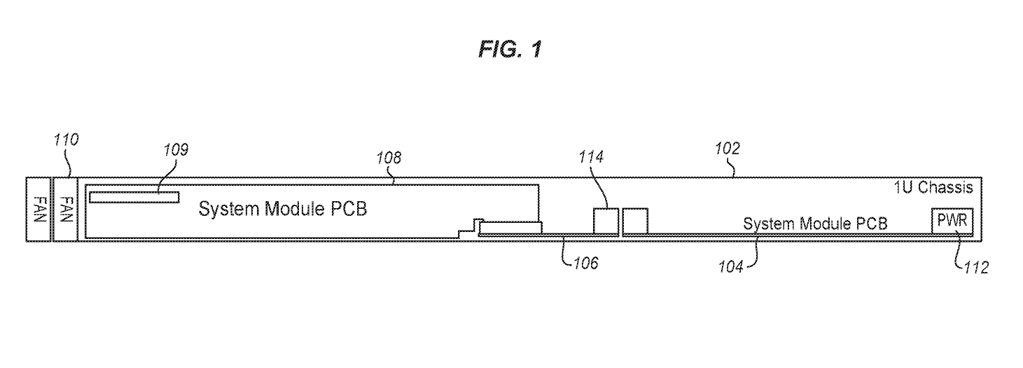

FIG. 1 is a cross-sectional side view diagram of an example of a rack-mount chassis and enclosure to accommodate the RSM's as described herein. The system has an enclosure 102 which in this case is a 1U height rack mount enclosure. The enclosure is configured to mount in a particular type of standardized rack that has airflow from the front or left as shown in the diagram to the rear or right as shown in the diagram. The rear is configured for cabling. The enclosure is about 19″ (483 mm) wide and 33″ (840 mm) deep. The 1U form factor is 1.75″ (44 mm) high. However, the particular width, height, and airflow direction may be adapted to suit other form factors.

The enclosure 102 carries a system module PCB (printed circuit board) 104 proximate the rear of the enclosure, a midplane PCB 106 near the middle of the enclosure and an array of RSMs 108 proximate the front of the enclosure. An array of fans 110 is mounted to the front of the enclosure to draw air into the enclosure and push it between and across the RSMs and to the rear of the enclosure. One or more power supplies 112 are mounted at the rear of the enclosure and may also have fans to draw air from the enclosure and push it out the rear of the enclosure. There may be additional fans along the chassis from front to rear. Rear fans may be used to pull air from the front across the chassis. Fans may be used in the middle of the chassis in addition to or instead of the front or rear fans to pull air in from the front and push it out the rear.

The configuration may be considered to have three zones a front memory zone 170 that in this example is about 16″ (400 mm) deep, a central midplane zone 172 that is about 8″ (200 mm) deep and a rear power supply and compute zone 174 that is also about 8″ (200 mm) deep. The relative sizes of these zones may be adapted to suit different configurations. The memory array consumes about half of the enclosure so that the rear half of the enclosure may be configured to suit different applications of the system.

In the memory card zone 170, the parallel memory cards extend from a position proximate the front of the enclosure toward the rear of the enclosure. This is followed by the switching zone 172 proximate the front of the enclosure and connected to the memory cards to carry a switch fabric. This is where the midplane lies. The rear zone 174 has power supply and management between the memory card zone and a rear of the enclosure. This zone may also be the switch zone that carries the switch fabric. In this case the midplane carries only a connector matrix to couple the power supply and management zone to the memory card zone. This middle zone may also be a compute zone which performs computations using values stored in the memory card zone.

The system may also be considered to have a rear fan zone 176 between the power supply and management zone and the rear of the enclosure to pull air from the memory card zone out the rear of the enclosure. The rear fan zone cooperates with a front fan zone 178 between the memory cards and the front of the enclosure to push air from outside the enclosure to the memory card zone.

The front fans and the rear power supply provide a push of air from the front and a pull of air from the rear to establish air flow across the RSMs, the midplane and the system module. The number and arrangement of the fans may be modified to suit the cooling and module requirements of the system. The system may have no front fans or no power supply fans and rely only on the push or the pull or both. While common power supplies include fans, the power supplies may not have fans. Instead separate rear fans may be used. Additional rear fans may be used to supplement the pull of the power supply fans. In some embodiments, the power supplies are provided in a separate enclosure and rear fans may be used without power supplies.

The system module 104 may be provided to suit different requirements, depending on the intended use of the system. The system module may be a data interface or a switching interface to connect the RSMs to external connectors through wired or wireless interfaces. It may include a memory controller to manage access to the RSMs and provide memory management and maintenance. It may include a data processing system to provide server, computing, and other functions between the RSMs and external devices.

The midplane 106 provides a connection between the RSM's and the system module, including a power interface to the RSMs. The midplane may also provide memory management and mapping between the RSMs and the system module. As shown, the mid plane PCB is mounted horizontally and orthogonal to the RSMs. The horizontal orientation of the mid-plane eliminates the need to design cavities into the mid-plane to accommodate air flow. This greatly simplifies mid-plane design and signal routing.

The RSMs 108 contain all the flash memory, such as NAND flash and the memory controllers that are needed to store user data. Each RSM also works as part of an airflow channel for guiding the air that is blown in by the front mounted fans and blown out by the fans in the power supplies in a push-pull model. By using thin and long form factor SSDs in a single row format, the surface area of the SSD card is maximized, with excellent airflow characteristics.

With the vertical and parallel flash modules extending orthogonal to the midplane, the storage may be very dense. All the area is being effectively used, with excellent airflow characteristics. Using 32 RSMs with 32 TB capacity in a 19″ SSD enclosure, the system could have a storage density of up to 1 PetaByte in a 1U height rack chassis. Emerging 3D NAND chips allow for 1 TB of NAND memory on a single chip. By placing 18 such chips on each side of each RSM and placing 32 RSMs in the enclosure a 1U 19″ Storage system can replace two full racks of 1 TB HDDs. The parallel orthogonal RSM configuration allows for very tight RSM-to-RSM spacing so that more RSMs may be fit into a single chassis system enclosure while maintaining very good air flow for system cooling.

The RSM also includes a display 109 attached to the exterior of the RSM. This may be a persistent or bistable display that shows the operational status of the RSM. The display is driven by a memory controller inside the RSM and is updated for any status change that is suitable for display on the card. The display is easily seen on the side of the RSM whether the RSM is mounted inside the system, as shown, or removed from the system. In this example, the display is near the front of the system where cool air enters the system. This reduces thermal stress on the display.

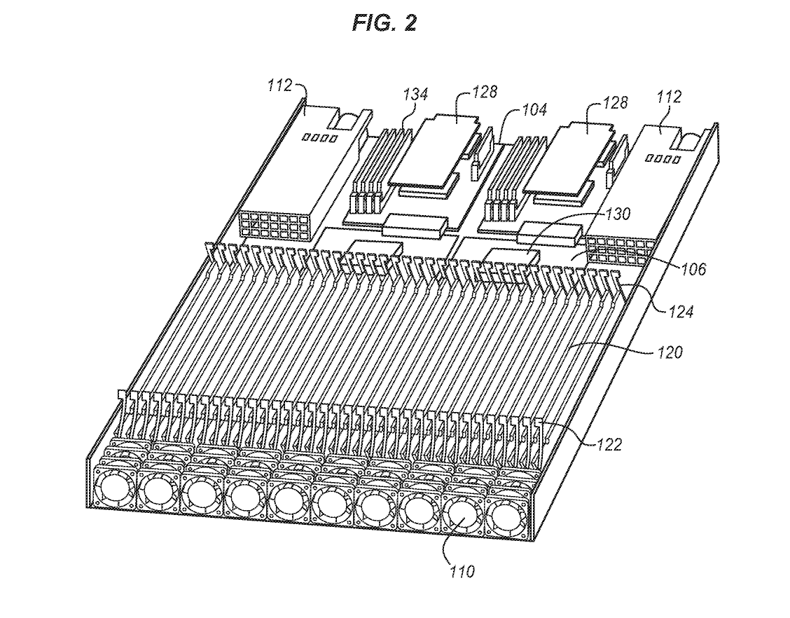

FIG. 2 is an isometric view diagram of the system of FIG. 1 with the top cover of the enclosure removed. There are several fans 110 in the front pulling air from outside, followed by 32 slots 120 for Ruler SSDs 108 (not shown), and followed by modular connectivity and compute modules at the back. There are two redundant power supplies 112 on the sides at the back of the enclosure. These power supplies have fans which are pushing air out of the box.

The slots 120 have front 122 and rear 124 latches, levers, or clips to hold each RSM in place. The slots are attached to the midplane and have connectors near the rear for data communications and power with the midplane. Because the slot connectors are in the horizontal midplane and connect to the bottom edge of the RSMs, the connectors do not interfere with airflow between the RSMs. The clips rotate to hold the RSMs in place against the slots. There are a variety of other types of connectors that may be used for the RSMs.

The system board 104 in this example is an interchangeable component that may be selected for different connection configurations. In this case there are two system boards. Each one has a switching complex 134 to provide switching between the different RSMs and an interface 128 that provides connections to external components. The interface may take any of a variety of different forms depending on the system needs. The interface may be a network interface, a storage array interface, or a direct memory connection interface.

PCIe (Peripheral Component Interconnect express) interconnect with an NVMe (Non-Volatile Memory express) storage protocol may be supported by the switching fabric 134 and the external interface 128. In this case, the NVMe is supported at the external interface and may also be supported in the connection to each RSM as well as within each RSM. Other PCIe interconnect protocols may alternatively be used. In addition SAS (Serial Attached Small computer system interface), SATA (Serial Advanced Technology Attachment), or other related, similar or different storage protocols may be used.

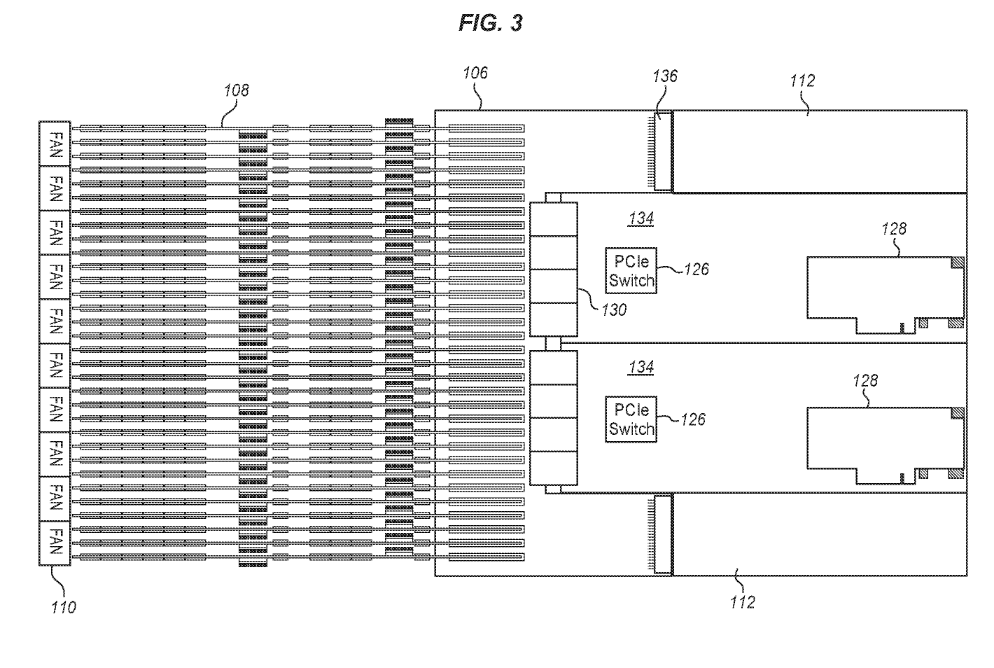

FIG. 3 is a top view diagram of a variation of the memory system of FIG. 2.

A high level architecture is shown of a variation of a 19″ SSD. The array of fans 110 are at the front of the enclosure and blow air across the array of SSDs 108. In this example there are 10 fans to blow air across 32 SSD memory cards. The precise number of fans may be adapted to suit the dimensions of the enclosure and particular type and configuration of fan and any other guides, shrouds, or other structures. The cards are placed vertically and aligned to be parallel to each other. The cards connect to a midplane 106 that has 32 connectors, one for each card. The connectors are at the rear end of the card. The connector may take a variety of different forms. The midplane is connected to a system module. The system module PCB is not visible in this view because it is covered by other components.

The midplane is coupled through a power connector 136 on left and right sides of the midplane (top and bottom as shown) to a left and right side power supply 112. These power supplies may be complementary or redundant and the midplane may be wired so that both power supplies are coupled to each RSM.

The midplane base board is also coupled through an array of data connectors 130 to two switching modules 134. The left module serves the 16 RSMs on the left and the right module serves the 16 RSMs on the right. The RSMs may also be cross-coupled so that each RSM is coupled to both modules or connected in any of a variety of different patterns that include various types of redundancy.

The switching modules may contain any of a variety of different components, depending on the implementation. In this example, there is a PCIe switch 126 for each module and a network interface card (NIC) 128 for each module. The NICs allow for an Ethernet connection to external components. The Ethernet connection is converted to PCIe lanes for the RSMs. Each RSM may use one or more lanes of a PCIe interface depending on the speed and the amount of data for the particular implementation. The switching modules may also include system management sensors and controllers to regulate temperature, monitor wear and failures and report status. While switching modules are shown, other types of modules may be used including server computers that use the RSMs as a memory resource.

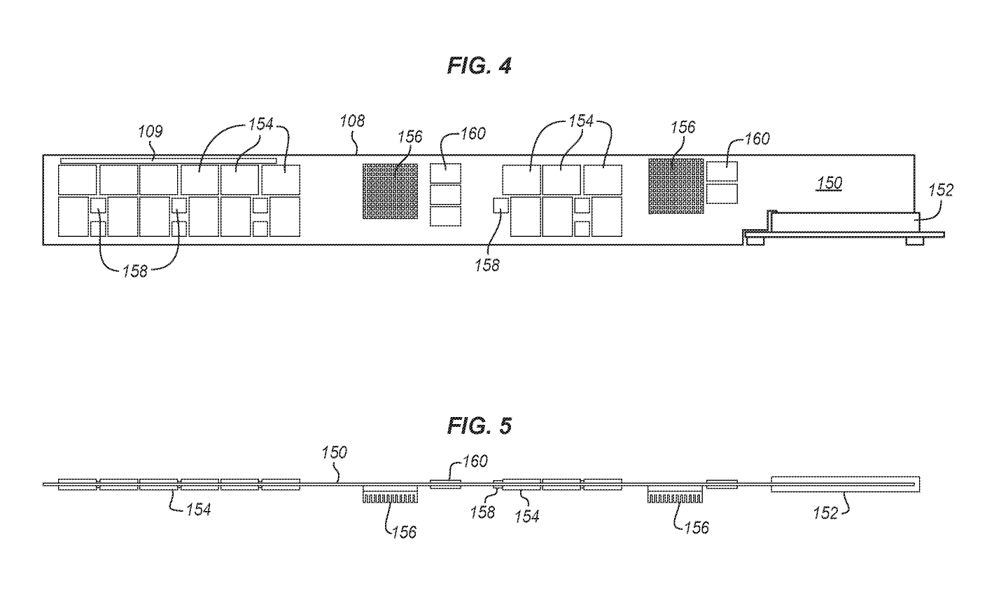

FIG. 4 is a side plan view diagram of an RSM or memory card 108 suitable for use with the memory system as described herein. The card has a printed circuit board (PCB) structure 150 with a connector 152 to the midplane at one end. Multiple memory chips 154, in this case eighteen chips are mounted to one side of the PCB structure. There may be more or fewer depending on the application. Each memory chip generates heat with use and consumes power with read and write operations. The number of chips may be determined based on power, cost, heat, and capacity budgets. In some embodiments 3D NAND flash memory chips are used. However, other types of solid state memory may be used including PCM (Phase Change Memory), STTM (Spin Transfer Torque Memory), magnetic, polymer, and other types of memory.

The memory card further includes memory controllers 156 to control operations, manage cells, mapping, and read and write between the connector 152 and the memory chips 154. Fan out hubs 158 may be used to connect the memory controllers to the cells of each memory chip. Buffers 160 may also be used to support write, read, wear leveling, and move operations.

The memory card further includes the display 109 coupled to the memory controller 156 to display status, codes, and faults of the memory card. The display is coupled to the memory controller through the PCB structure and may also be coupled to an external controller through the connector 152.

FIG. 5 is a top view of the memory card of FIG. 4 showing the same components. The card may be configured to support more memory chips on the other side or only one side may be used, depending on the budget for power, heat, and capacity. The memory card may have heat sinks and exposed chip package surfaces as shown, or may be covered with one or more larger heat sinks or heat spreaders as well as protective covers.

The particular configuration and arrangement of the chips may be modified to suit requirements of different chips and to match up with wiring routing layers within the PCB. The buffers may be a part of the memory controllers or in addition to those in the memory controllers. There may be additional components (not shown) for system status and management. Sensors may be mounted to the RSM to report conditions to the memory controller or through the connector to an external controller or both.

The RSM allows a large amount of NAND flash memory to be packed into a small design. In this example with 1 TB of memory per NAND chip 154, 36 TB of memory may be carried on a single memory card. This amount may be reduced for lower cost, power, and heat and still use the same form factor. The Ruler Storage Module is shown with a bottom connector. This allows modules to be replaced by removing a top cover of the chassis for top serviceable enclosure. Typical equipment racks allow the enclosure to slide forward to allow access without removing the enclosure from the rack. This same structure and system of operation may be used in this embodiment.

The Ruler Storage Module provides optimized airflow and a maximal surface area for storage media. This new storage module allows for a 1U high, extremely dense SSD solution. This new storage module form factor does not hinder airflow in the system and yet is dense enough to provide a great advantage over existing form factors that were developed for other purposes, such as 2.5″ notebook drives, AIC (Advanced Industrial Computer) memory, M.2 cards, and Gum-stick memory (typical USB stick style configurations). Some of these form factors cannot be used in a 1U height enclosure in any arrangement.

The RSMs provide quick and secure connections and may be configured to be hot-swappable in some systems. Using modular compute and connectivity blocks for the 19″ SSD system described herein, one can easily, without system shut-down, swap out a compute module and insert a new compute module with varying compute horse power, depending upon the storage solution requirements, within the 19″ SSD enclosure. For example, a low power compute module, such as an Intel® Atom® processor-based system may be used for storage targets that need mid-range compute capabilities, such as Simple Block Mode Storage, NVMe of Fabrics, iSCSI/SER, Fiber Channel, NAS (Network Attached Storage), NFS (Network File System), SMB3 (Server Message Block), Object store, distributed file system etc. A higher performance processor on the compute module may be used for Ceph nodes, Open Stack Object, Custom Storage Services and Key/Value Stores. For very high performance, the computing module may be in a different enclosure on the same or another rack and connected using PCIe switches or another memory interface.

In addition to providing interchangeable RSMs, the same chassis and enclosure may allow for the system modules to be interchangeable. This may allow for different connectivity modules to be used. The system may be upgraded to a different storage protocol (e.g. NVMe over Fabrics RDMA (Remote Direct Memory Access), iSCSI (internet SCSI), NVMe or even Ethernet) without changing any of the RSMs. This modularity also enables two modules to be used for redundancy and fail-over in some applications (e.g. traditional enterprise storage) and a single module for other applications (e.g. cloud computing).

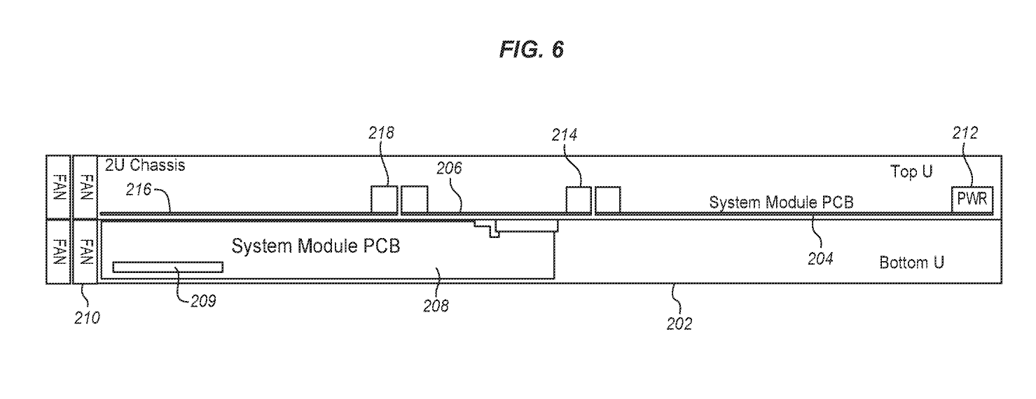

FIG. 6 is a diagram of an alternative chassis enclosure for a 2U (3.5′ or 89 mm) rack height. In this enclosure, the same memory card configuration is used for 1PB plus of storage. The additional height allows for additional computing and switching components to be included with short fast connections to the memory. In this example, there is an array of memory cards 208 proximate the front of the enclosure coupled through connectors to a midplane PCB 206 near the center of the enclosure. The midplane is coupled through connectors 214 to a system module PCB 204 at the rear of the enclosure. There is a front fan zone with an array of fans 210 to push air across the memory cards 208 and a rear power supply 212 fastened to or adjacent to the system module PCB 204 proximate the rear of the enclosure to pull air out of the chassis.

As in the example of FIG. 1, each memory card may also include a persistent display 209 on the exterior of the card to display the status of the card. The status can be observed when the card is installed and also before and after it has been removed from the chassis.

In contrast to the 1U configuration, the system module may be on either the lower or upper side of the enclosure. The RSMs have the same configuration and therefore use only one half of the 2U chassis. In this example, the RSMs are in the lower half of the enclosure but could alternatively be in the upper half. The system module is in the upper half opposite the RSMs. Due to the PCB structure of the midplane and the system module, the PCBs are in the center of the enclosure and horizontal while the components on the PCBs extend vertically from the PCBs into the upper half of the enclosure. An additional system module (not shown) may also be added to the lower half of the enclosure at the rear of the enclosure.

The 2U configuration also allows an additional system module PCB 216 to be added at the front of the enclosure above the RSMs. As mentioned, the RSMs may be in the upper half, in which case, the additional system module may be in the lower half instead. The additional system module may be used to provide computing power or additional switch fabric. As an example, the rear system module may be used as interface, switch fabric, and power supply, while the front system module is used as a computing zone with microprocessors and memory for low power or high power computing. Alternatively, the front system module or an additional rear module may be used for PCIe adapter cards for graphics rendering, audio or video processing, or other specialized tasks.

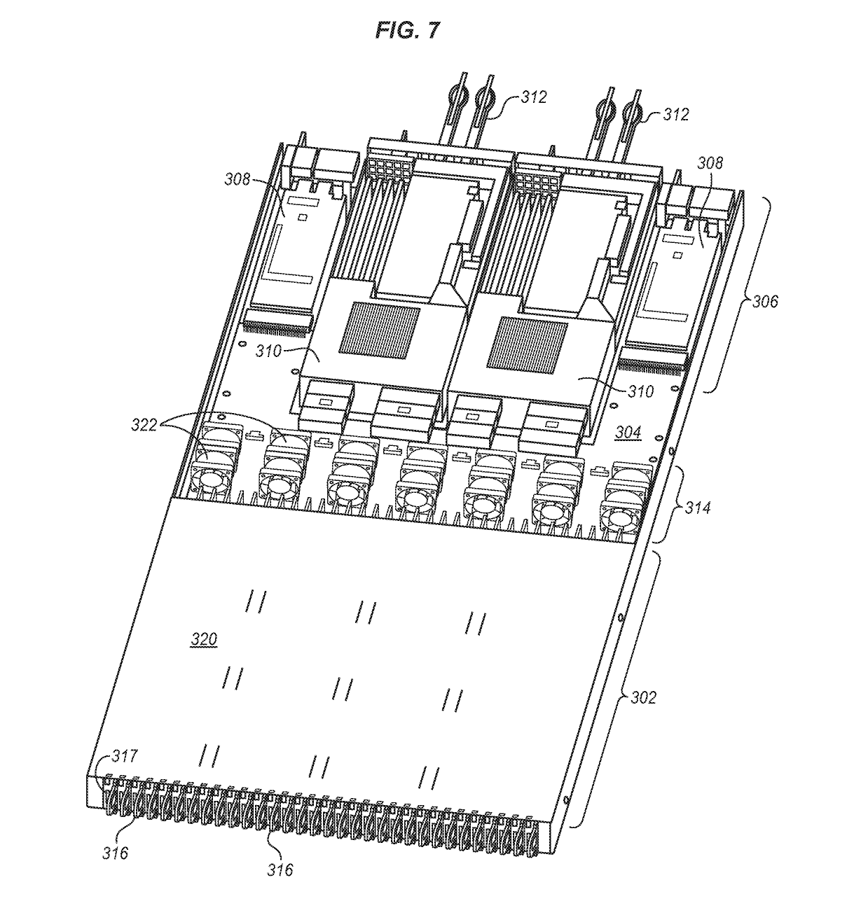

FIG. 7 is an isometric diagram of an alternative chassis enclosure for a 1U rack height. This configuration may be augmented by an extra layer for additional computing, switching, interface, or power supply resources. The front of the chassis has a memory ruler zone 302. In this example, the rulers are covered by a top cover 320 which may also act to guide air across and between the rulers. A horizontal plane board in the form of a midplane 304 is directly beneath and coupled to the rulers. The rulers extend orthogonally upward from the top side of the midplane. A power supply and management zone 306 includes power supplies 308 on either side of the enclosure.

Compute modules 310 are placed side-by-side between the power supplies 308 and proximate the rear of the enclosure. The compute modules include external interface components that couple to cabling 312. The cabling connects the memory system to external component on another position on the rack or to another rack. As in all of the other embodiments, the compute modules may be limited to serving and storing data and converting to and from different formats. The compute modules may be more powerful and able to perform simple tasks at low energy or more complex computation and modeling tasks, depending on the particular implementation.

A fan zone 314 is placed near the center of the enclosure with an array of fans 322 across the width of the chassis. There are seven fans in this example, but there may be more or fewer as mentioned above. The fans pull air from the front of the chassis between the memory rulers and then push it out the rear of the enclosure. They may be helped by the power supply and compute module fans, if any, and by additional rear fans, if any. The intermediate fan zone is placed between the memory rulers and the power supplies on the same side of the midplane as the memory rulers.

In this example there are no front fans shown. Front fans may be used to improve air flow or reduce the load on the middle fans. Instead the memory rulers have handles 316 at the front of the enclosure to allow access to the respective ruler. Fans may be mounted in front of these handles, in which case, the fans may be moved to access the memory rulers. The front handles allow for front access to the memory rulers without sliding the chassis forward in the rack as with the top mounted version described above.

In this example, each memory ruler also has a display 317 on the front face of the memory ruler. This display allows a technician to read the status of each memory ruler without moving the chassis. The side display 109, 209, is not visible until the memory ruler is removed or the chassis slides out for access to the sides of the cards without removing the cards. The front display is visible immediately without moving any components. If there are fans at the front of the chassis as in FIG. 2, then the front displays may be visible through the fans or by moving a fan temporarily to see a display.

The front displays may simply provide a color, such as green for good, red for bad, or yellow for compromised. Only one color is needed. Red or the absence of green may be used to determine that a memory ruler should be pulled using the front handle 316. The absence of green may also be used to indicate the chassis should be pulled forward so that more detailed status information may be noted from the larger side display 109, 209.

The front display may also or alternatively provide an abbreviated status such as “OK” or “FAIL” together with any other important operational data, such as load, internal temperature, access rate, etc.

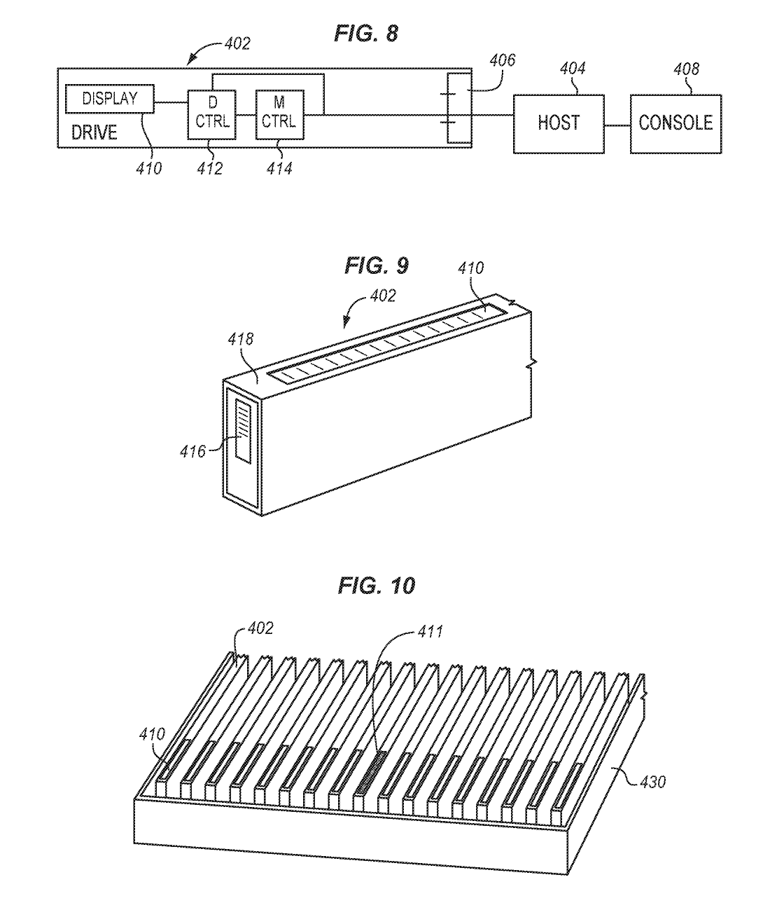

FIG. 9 is a block diagram presented as a side view of a memory card 402 such as the RSM described above showing components related to the persistent display. The RSM will also include many other components such as memory arrays, data interfaces, power regulators and other components as described above. While this memory card is particularly configured as an array of flash memory chips, the same components may also be used for other types of memory.

The memory card is connected through a connector to a host 404. As described above, the host may be a computer or a data interface to external computing and networking resources. In addition, the host monitors the condition and use of the memory card and transmits status and operational information to a remote management console 408. The host occupies the same chassis and manages the memory cards of the system. This management generates information as wear rates, hardware utilization, environmental parameters, and other information about the system that the host may send to the management console 408. At the same time this information may be written to persistent displays on a memory card.

The host is also coupled through the connector 406 to a memory controller 414. The memory controller is coupled to a display controller 412 and the display controller is coupled to a display 410. There may be one or more displays driven by the display controller.

The host communicates with the memory controller to exchange status, operational parameters, memory mapping and other factors. This communication may be through an I2C (Inter Integrated Circuit) bus, an SMBus (System Management Bus) or any of a variety of other interfaces. These interfaces are low speed, low pin count interfaces for low bandwidth information transfers. I2C for example, may have multiple masters and multiple slaves all communicating over two pins. This allows either one of the controllers to write to one or more displays. Since the amount of data required to communicate a status or an error code is very small, a low power, low speed bus is more than enough. However, in some embodiments an existing high speed bus that is used for other purposes may be used to also convey information to the display controller.

The host controller may send data to the memory controller. The memory controller may then send the data to the display controller to write the data on the display. The host controller may be coupled directly the display controller so that the display may be updated even if there is a failure of the memory controller. Similarly the memory controller may write to the display even if the connection to the host is lost.

FIG. 9 is an isometric view of a portion of an exterior casing 418 for a memory card 402. The casing may be used to protect the components inside as well as to provide a heat sink for the memory and controller dies. In this example, the memory card has two displays. There is a main top display 402 for detailed information and a front display 416 for quick status information or more urgent information. For a rack mount chassis with the memory cards aligned facing toward the front of the chassis, the front display may be visible in normal use. The top display may be visible only when a top cover is removed or when the memory card is removed from the chassis.

Using multiple E-ink® displays, one display may be used for status codes and error codes. This would be the display that is easier to view. The other display may be used for more detailed information, such as memory utilization, memory fill levels, service hours, estimate time to failure, reasons for a noted failure, type of failure, date and time of the failure, etc. The display may also include identifying information such as the slot number into which the memory was installed, the chassis into which the memory was installed, temperature in the chassis, and other environmental parameters.

FIG. 10 is an isometric view of a part of a chassis 430 with an installed array of memory cards 402. This diagram shows that color may also be used to aid a technician. In this example each memory card has a display 410 that is visible when the top of the cabinet is opened. There may be additional displays (not shown) that are more readily visible from other positions. As an example, if the front of the chassis is transparent or has windows, then a front display 416 may be visible as described in the context of FIG. 7. One of the top displays 411 is colored. This display may be red, orange, yellow, or some other color to indicate that the memory card has failed or otherwise requires attention. Alternatively, the display may be uncolored while the other displays are colored.

Using a single color and applying it only to failed cards or cards that require attention makes it very easy for the technician to find the card even in a large array. Using a second color, healthy cards may have green displays or displays in some other color. Additional colors and even full color displays may be used to show different status levels. These colors may be used on a front display 416 or any other display. With an electrophoretic display, the cost for adding one color to a display is much lower than for a full color display. The display driver and display controller are also much simpler for a single color plus black and white display.

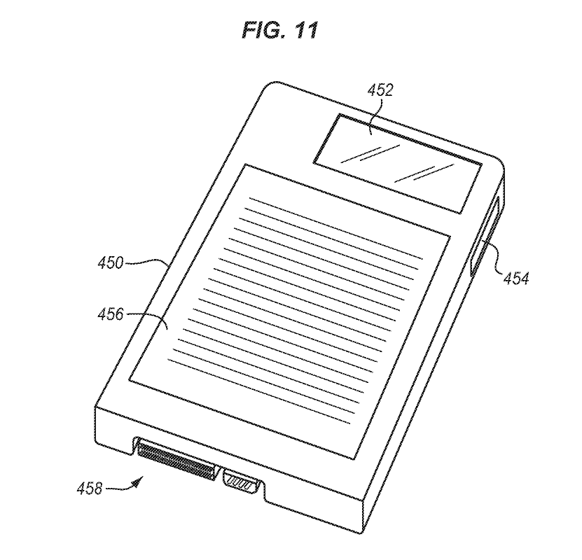

FIG. 11 is an isometric view of a different memory form factor developed for hard disk drives but also used for solid state drives and other types of memory devices. The techniques described herein may be applied to an all flash array using such a form factor with appropriate modifications to the chassis and enclosures described herein. In this case, the memory device has a rectangular thin housing 450 that contains one or more printed circuit boards with memory controllers, memory, a display controller, and an external interface 458 as described above.

There are two or more displays 452, 454 on the exterior of the housing. These are on different surfaces of the housing so that they are visible from different positions. In this example, a small display 454 on an edge of the housing is visible when the housing is arranged in a housing that carries an array of such drives. A larger primary display 452 is located next to a printed label 456 on a top surface of the drive and is visible when the drive is removed from the chassis. The location and configuration of the displays may be adapted to suit the chassis and enclosure with which they will be used.

The persistent indication of status or error information significantly changes the serviceability of a memory array chassis. The display greatly improves the usability of an array of memory drives. In a large array, such as an all flash array, in which multiple such drives are installed in the same chassis, the persistent indication for a failed drive allows the technician to immediately determine where the fault is and then to replace the failed or failing part. The display may also be used to indicate the nature of the failure or warning.

In addition, after the drive is removed from the system, it will likely be placed in a location with other failed or failing drives. Typically the technician no longer knows why the drives were pulled or must correlate drive serial numbers to diagnostic data of a central administrative console and attach that diagnostic data to each pulled drive. Using the persistent display, it is very easy to determine the circumstances for each drive that has been pulled from an enclosure. An LED based indication mechanism only works while the drive is in the system and is powered and working properly. In addition, an LED does not convey very much information. If multiple LEDs are used to show error codes, then the codes are difficult to interpret. With the persistent display, the drive status may be read directly from the one or more displays on the exterior of the drive. The display may show alphanumeric text, pictures, or any other desired information or symbols. The drive need not be powered, installed, or in the original enclosure from which it was pulled.

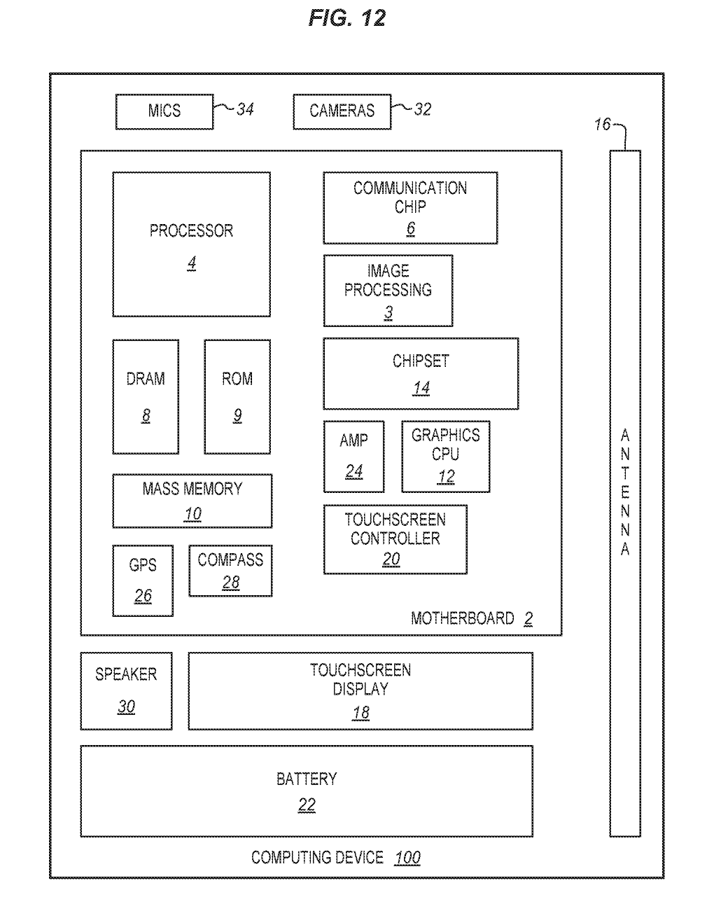

FIG. 12 is a block diagram of a computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The computing system may be configured to be used as the system module. The computing system also reflects the entire rack-mount memory system where the mass memory is formed from multiple memory cards, as described. The memory system may have multiple iterations of the computing system within a single enclosure for each system module and also for the overall system.

In various implementations, the computing device 100 may be an entertainment front end unit or server, a music or video editing station or back end, a cloud services system, a database, or any other type of high performance or high density storage or computing system.

Embodiments may be include one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to an apparatus that includes an external housing, a persistent display attached to the exterior of the housing, a display controller within the housing coupled to the display to write status data to the display, a memory array to store data within the housing, a memory controller within the housing to control the operation of the memory array and to determine a status of the memory array, the memory controller being coupled to the display controller to send status data to the display controller to write to the display, and an exterior connector coupled to the memory controller to send data from the memory to an external device.

In further embodiments the display is an electrophoretic display.

In further embodiments the display controller writes to the display when the apparatus is powered and the display maintains the status data after power is removed from the apparatus.

In further embodiments the apparatus is configured to be installed into a chassis to receive power and wherein the display is configured to be visible when the apparatus is installed into the chassis.

In further embodiments the status data includes error codes.

Further embodiments include a serial connection bus to connect the memory controller to the display controller.

In further embodiments the bus is further connected to an external host, wherein the host determines status including fault conditions of the apparatus and sends status data to the memory controller to write on the display.

In further embodiments host is further connected to the display controller to send status data to write on the display when the memory controller is not available.

In further embodiments the status data includes usage statistics.

In further embodiments the display further comprises a color and wherein the display controller writes a color to the display to indicate a status.

Some embodiments pertain to a removable memory device that includes a memory array to store data, a memory controller to control the operation of the memory array, an external connector coupled to the memory controller to send stored data from the memory to an external device, a persistent display visible from the exterior of the device, a display controller coupled to the display to write data to the display, and a control bus coupled to the external device, to the memory controller, and to the display controller, wherein the display controller receives status data to write to the display through the control bus and receives status data from the external device through the control bus to write to the display.

In further embodiments the status data includes usage statistics.

In further embodiments the control bus comprises a serial bus separate from the external connector.

Some embodiments pertain to a memory system that includes an enclosure configured to mount in a rack, the enclosure having a front configured to receive airflow and a rear configured for cabling, a horizontal plane board in the enclosure having a plurality of memory connectors and a plurality of external interfaces, the horizontal plane board having a first side and a second opposite side, a plurality of memory cards, each having a connector to connect to a respective memory connector of the horizontal plane board and extending orthogonally from the first side of the horizontal plane board to the front of the enclosure, each memory card having a housing, a persistent display attached to the exterior of the housing, a display controller within the housing coupled to the display to write status data to the display, a memory array within the housing to store data, and a memory controller within the housing to control the operation of the memory array and to determine a status of the memory array, the memory controller being coupled to the display controller to send status data to the display controller to write to the display, and to the memory connector to send data from the memory to the horizontal plane board, and a cabling interface at the rear of the enclosure coupled to the external connectors.

In further embodiments the memory card housing comprises an external heat sink to transfer heat from the memory array to air flowing between the memory cards.

Further embodiments include a system board, a computing platform mounted to the system board, and a switching fabric coupled between the midplane board and the computing platform is mounted to the system board.

In further embodiments the computing platform determines status including fault conditions of each memory card and sends status data to the respective memory controller to write on the display.

In further embodiments computing platform is further connected to the display controller of each respective memory card to send status data to write on the display when the memory controller is not available.

In further embodiments the display is an electrophoretic display.

In further embodiments the display controller writes to the display when the apparatus is powered and the display maintains the status data after power is removed from the apparatus.

What is claimed is:

1. An apparatus comprising:
an external housing;
a persistent display attached to the exterior of the housing;
a display controller within the housing coupled to the display to write status data to the display;
a memory array to store data within the housing;
a memory controller within the housing to control the operation of the memory array and to determine a status of the memory array, the memory controller being coupled to the display controller to send status data to the display controller to write to the display; and
an exterior connector coupled to the memory controller to send data from the memory to an external device.

2. The apparatus of claim 1, wherein the display is an electrophoretic display.

3. The apparatus of claim 1, wherein the display controller writes to the display when the apparatus is powered and the display maintains the status data after power is removed from the apparatus.

4. The apparatus of claim 2, wherein the apparatus is configured to be installed into a chassis to receive power and wherein the display is configured to be visible when the apparatus is installed into the chassis.

5. The apparatus of claim 1, wherein the status data includes error codes.

6. The apparatus of claim 1, further comprising a serial connection bus to connect the memory controller to the display controller.

7. The apparatus of claim 6, wherein the bus is further connected to an external host, wherein the host determines status including fault conditions of the apparatus and sends status data to the memory controller to write on the display.

8. The apparatus of claim 7, wherein the host is further connected to the display controller to send status data to write on the display when the memory controller is not available.

9. The apparatus of claim 1, wherein the status data includes usage statistics.

10. The apparatus of claim 1, wherein the display further comprises a color and wherein the display controller writes a color to the display to indicate a status.

11. A removable memory device comprising:
a memory array to store data;
a memory controller to control the operation of the memory array;
an external connector coupled to the memory controller to send stored data from the memory to an external device;
a persistent display visible from the exterior of the device;
a display controller coupled to the display to write data to the display; and
a control bus coupled to the external device, to the memory controller, and to the display controller,
wherein the display controller receives status data to write to the display through the control bus and receives status data from the external device through the control bus to write to the display.

12. The memory device of claim 11, wherein the status data includes usage statistics.

13. The memory device of claim 11, wherein the control bus comprises a serial bus separate from the external connector.

14. A memory system comprising:
an enclosure configured to mount in a rack, the enclosure having a front configured to receive airflow and a rear configured for cabling;
a horizontal plane board in the enclosure having a plurality of memory connectors and a plurality of external interfaces, the horizontal plane board having a first side and a second opposite side;
a plurality of memory cards, each having a connector to connect to a respective memory connector of the horizontal plane board and extending orthogonally from the first side of the horizontal plane board to the front of the enclosure, each memory card having a housing, a persistent display attached to the exterior of the housing, a display controller within the housing coupled to the display to write status data to the display, a memory array within the housing to store data, and a memory controller within the housing to control the operation of the memory array and to determine a status of the memory array, the memory controller being coupled to the display controller to send status data to the display controller to write to the display, and to the memory connector to send data from the memory to the horizontal plane board; and
a cabling interface at the rear of the enclosure coupled to the external connectors.

15. The system of claim 14, wherein the memory card housing comprises an external heat sink to transfer heat from the memory array to air flowing between the memory cards.

16. The system of claim 14, further comprising a system board, a computing platform mounted to the system board, and a switching fabric coupled between the midplane board and the computing platform is mounted to the system board.

17. The system of claim 16, wherein the computing platform determines status including fault conditions of each memory card and sends status data to the respective memory controller to write on the display.

18. The system of claim 17, wherein computing platform is further connected to the display controller of each respective memory card to send status data to write on the display when the memory controller is not available.

19. The system of claim 14, wherein the display is an electrophoretic display.

20. The system of claim 14, wherein the display controller writes to the display when the apparatus is powered and the display maintains the status data after power is removed from the apparatus.
